(19) United States
(12) Patent Application Publication
(10) Pub. No.: US 2025/0191827 A1
(43) Pub. Date: Jun. 12, 2025

(54) ASSEMBLIES AND METHODS FOR ELECTRO-MAGNETIC ASSEMBLIES HAVING WIRE GAP SPACERS

(71) Applicant: ABB Power Electronics Inc., Plano, TX (US)

(72) Inventor: Robert James Catalano, Plano, TX (US)

(21) Appl. No.: 18/530,972

(22) Filed: Dec. 6, 2023

(51) Int. Cl. H01F 27/26; H01F 41/02

(52) U.S. Cl. CPC H01F 27/263; H01F 41/0206

(57) ABSTRACT

An electro-magnetic assembly is provided. The electro-magnetic assembly includes a core including a core base and a core top, the core defining a depression sized to receive a winding. The electro-magnetic assembly further includes a gap spacer including one or more wires positioned between the core base and a core top.

### BACKGROUND

The field of the disclosure relates to electro-magnetic assemblies, and more particularly, to assemblies and methods for electro-magnetic assemblies having wire gap spacers.

An electro-magnetic assembly may be a device such as a transformer or an inductor. A gap is included in the core of the electro-magnetic assembly for many different reasons. Known gap spacers in electro-magnetic assemblies are disadvantaged in some aspects and improvements are desired.

### BRIEF DESCRIPTION

In one aspect, an electro-magnetic assembly is provided. The electro-magnetic assembly includes a core including a core base and a core top, the core defining a depression sized to receive a winding. The electro-magnetic assembly further includes a gap spacer including one or more wires positioned between the core base and a core top.

In another aspect, a method of assembling an electro-magnetic assembly is provided. The method includes providing a core including a core base and a core top, the core defining a depression sized to receive a winding. The method further includes placing coils in the depression to construct the winding. The method also includes positioning a gap spacer including one or more wires on the core base, and depositing epoxy on the core base. In addition, the method includes assembling the core top with the core base into the electro-magnetic assembly, and curing the electro-magnetic assembly.

### DRAWINGS

Non-limiting and non-exhaustive embodiments are described with reference to the following FIGS., wherein like reference numerals refer to like parts throughout the various drawings unless otherwise specified.

FIG. 1A is a schematic diagram of a known electro-magnetic assembly.

FIG. 1B is the electro-magnetic assembly shown in FIG. 1A with the core top placed apart from the rest of the electro-magnetic assembly.

FIG. 2A is a schematic diagram of an example electro-magnetic assembly.

FIG. 2B is the electro-magnetic assembly shown in FIG. 2A with the core top and the winding being depicted apart from the rest of the electro-magnetic assembly.

FIG. 2C is a schematic diagram of another example electro-magnetic assembly.

FIG. 2D is the electro-magnetic assembly shown in FIG. 2C with the core top and the winding being depicted apart from the rest of the electro-magnetic assembly.

FIG. 3A is a schematic diagram of one more example electro-magnetic assembly.

FIG. 3B is the electro-magnetic assembly shown in FIG. 3A with the core top being depicted apart from the rest of the electro-magnetic assembly

FIG. 4 is a flow chart of an example method of assembling the electro-magnetic assemblies shown in FIGS. 2A-3B.

FIG. 5 shows testing results of comparing the performance of an electro-magnetic assembly disclosed herein with the known electro-magnetic assembly shown in FIG. 1.

### DETAILED DESCRIPTION

The disclosure includes electro-magnetic assemblies and methods of assembling electro-magnetic assemblies. As used herein, an electro-magnetic assembly is an assembly that includes a core and a winding wound around the core to produce magnetic flux in the core from electric current flowing through the winding. Electro-magnetic assemblies may be assemblies such as transformers or inductors. Inductors are described as examples for illustration purposes only. The assemblies and methods described herein may be applied to electro-magnetic assemblies in general. Method aspects will be in part apparent and in part explicitly discussed in the following description.

A gap is defined in an electro-magnetic assembly for many different reasons, such as keeping the electro-magnetic assembly from saturating. Gaps are typically placed on the magnetic core material mating surfaces. A gap may be ground into a leg of the core or by including a gap spacer in the core.

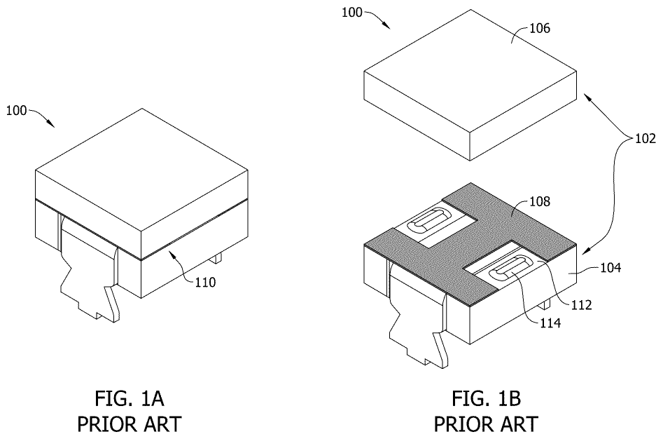

FIG. 1 shows a schematic diagram of a known electro-magnetic assembly 100. Electro-magnetic assembly 100 includes a core 102 having a core base 104 and a core top 106. Electro-magnetic assembly 100 includes a gap spacer 108 positioned between core base 104 and core top 106 to define a gap 110. Gap spacer 108 is typically fabricated with a non-magnetic and electrically nonconductive material, such as paper or Nomex®. The material is paper-like and impregnated with epoxy.

In assembling electro-magnetic assembly 100, gap spacer 108 of a desired shape is punched out. Gap spacer 108 is then manually placed on the faces 112 of core base 104. Epoxy 114 is deposited on core base 104. Core top 106 and core base 104 are assembled together. Electro-magnetic assembly 100 is then placed in an oven to cure epoxy 114 such that the bonding between core base 104 and core top 106 by epoxy 114 is hardened.

The manufacturing process of known electro-magnetic assembly 100 is expensive and time consuming because the placement of gap spacer 108 requires tedious manual labor and automation cannot meet the relatively tight tolerance of inductance of electro-magnetic assembly 100. The material for gap spacer 108 is in set thicknesses and only a limited number of set thicknesses, such as 0.5 mils (0.013 mm), 1 mil (0.025 mm), 3 mils (0.076 mm), 5 mils (0.13 mm), 10 mils (0.25 mm), 15 mils (0.38 mm), or 20 mils (0.51 mm), are commonly available. The material for the gap spacer tends to fold or crease and the thickness at the folds or creases may increase two or more times. Because the inductance of an electro-magneto assembly has a relatively tight tolerance, the tolerance for the thickness of the gap spacer is relatively tight. For example, the tolerance of the inductance should be 5-6 σ, where 5 σ is at 233 parts per million (ppm) and 6 σ is at 3.4 ppm. σ is the standard deviation of the inductance from the desired value and ppm indicates the number of defected products per million manufactured products. Two or more times of increases in the thickness of a gap spacer may increase the error to 2000 ppm, rendering the electro-magnetic assembly unsatisfactory for the intended applications. Accordingly, great care is required in placement of the gap spacer to ensure the gap spacer is placed at the desired location on the core and, more importantly, no fold or crease is present in the gap spacer. Further, because the thickness of the material for gap spacer 108 is in limited set thicknesses, if the desired thickness of gap spacer 108 is not among the limited available thicknesses, two or more sheets of the material at different thicknesses are needed to be assembled such that gap spacer 108 has the desired thickness. Again, the process to assemble a plurality of sheets is tedious and requires great care to ensure no fold or crease due to the relatively tight tolerance on the inductance of the electro-magnetic assembly. Although the deposition of epoxy may be automated, the only available manufacturing process to construct a gap in the core via a gap spacer 108 is via a manual process. A machine lacks the capability to pick up the gap spacer cut from a relatively thin paper-like material, place the cut material at a precise location on the core and without any fold and crease, or at times combine two or more sheets of the material to construct a gap spacer of a desired thickness.

Further, because gap spacer 108 is relatively thin, when core base 104 and core top 106 are placed together and press on epoxy 114, epoxy 114 may travel to above and/or below gap spacer 108, also affecting the thickness of gap 110 and the inductance of electro-magnetic assembly 100.

In contrast, the assemblies and methods disclosed herein solve the above-described problems in known electro-magnetic assemblies and known assembling methods of electro-magnetic assemblies. Wires are used as gap spacers. Gauges of wires, such as American wire gauges (AWG) or metric gauges, come in very small increments. Wires of various gauges, especially conductive wires, are readily available, even at a manufacturing facility and distributors of wires, especially at a manufacturing facility of electro-magnetic assemblies. As a result, changing the thickness of the space saver may be accomplished by simply selecting wires of a different gauge. Further, the epoxy flows around the wires without affecting the gap of the electro-magnetic assemblies and the inductance of the electro-magnetic assemblies. Folds or creases do not occur for wires placed on the core. The assembling methods described herein may be automated without compromise in meeting the tight tolerance of the inductance of the electro-magnetic assembly.

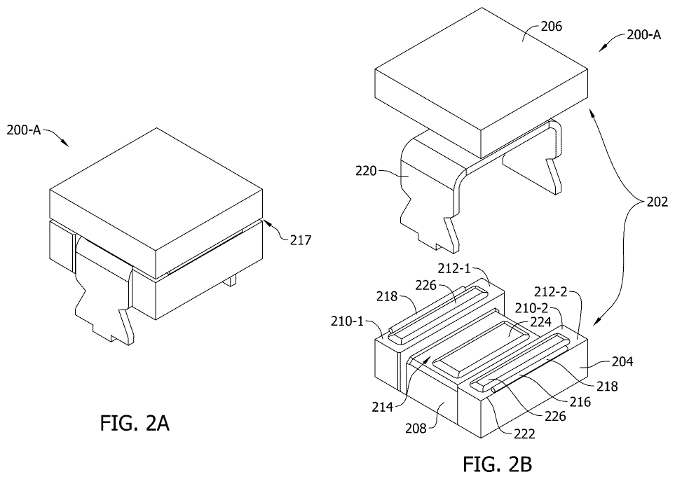

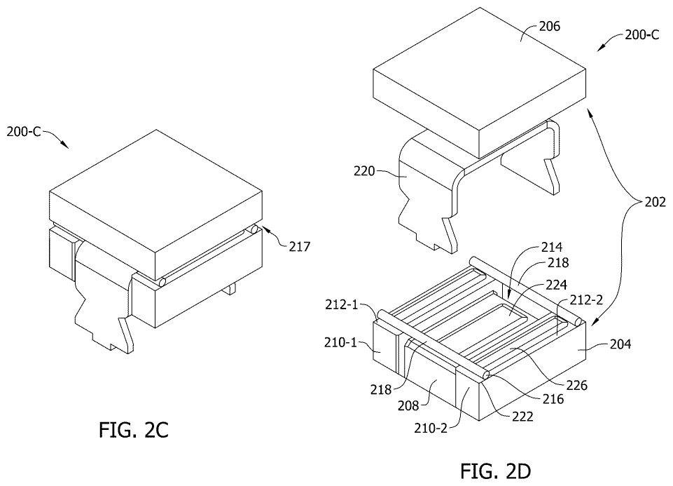

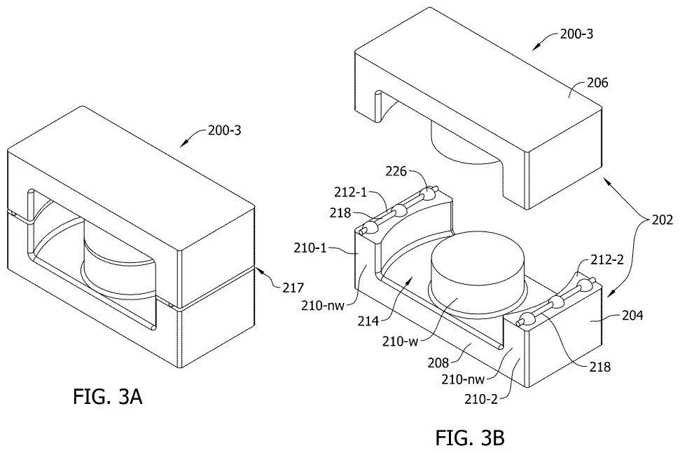

FIGS. 2A-2D show example electro-magnetic assemblies 200-A (FIGS. 2A and 2B), 200-C (FIGS. 2C and 2D). In the example embodiments, electro-magnetic assembly 200 includes a core 202. Core 202 includes a core base 204 and a core top 206. Core 202 shown in FIGS. 2A-2D is a UI core, where core base 204 is in the shape resembling letter U and core top is in the shape resembling letter I. Core base 204 includes a body 208 and one or more legs 210. Core base 204 shown in FIGS. 2A-2D includes a first leg 210-1 and a second leg 210-2. A first leg 210-1 defines a first leg face 212-1. A second leg 210-2 defines a second leg face 212-2. Legs 210 extend from body 208. Core 202 defines a depression 214 sized to receive a winding 220 therethrough. Depression 214 may be defined in core base 204, core top 206, or both (see FIGS. 3A and 3B described later). Depression 214 is positioned between first leg 210-1 and second leg. When assembled, legs 210 extend toward core top 206 with leg faces 212 facing core top 206.

In the example embodiments, electro-magnetic assembly 200 includes a gap spacer 216 for a gap 217. Gap spacer 108 includes one or more wires 218. Wire 218 having a round cross section is shown as an example for illustration purposes only. The cross section of wire 218 may be in other shapes, such as square or rectangle, that enable the electro-magnetic assembly 200 to function as described herein. Wire 218 may be electrically conductive or electrically nonconductive. Example wires may be magnet wires such as conductive wires fabricated with copper, aluminum, steel, and/or other material. A conductive wire may be coated with insulation or may not be coated with insulation. Example nonconductive wires may be fishing lines. Wires of different gauges in very small increments, especially conductive wires, are readily available, even in a manufacturing facility. Accordingly, gap 217 defined by gap spacer 108 readily has the desired size to meet the tight tolerance of inductance of electro-magnetic assembly 200, thereby eliminating the tedious manual process of assembling a plurality of sheets for a desired thickness in known methods. Two wires 218 are shown (FIGS. 2B and 2D, also see FIG. 3B) for illustration purposes only. Other number of wires, such as one or three, may be used to enable electro-magnetic assembly 200 to function as described herein. The length of wire 218 may be smaller than a dimension of core 202 (see FIG. 2B). The length of wire 218 may be approximately the same as the dimension of core 202 (see (FIG. 2D). Wires 218 may be in other lengths that enable electro-magnetic assembly to function as described herein.

In the example embodiments, wire 218 may be positioned on leg face 212 of leg 210 (FIG. 2B). The entire length of wire 218 may be positioned on leg face 212. Wire 218 may be positioned across depression 214, with one end positioned on first leg face 212 and the other end positioned on second leg face 212 (FIG. 2D). When high frequency alternate current (AC) signals are provided to a winding 220 and wires 218 are electrically conductive, losses from eddy current in conductive wires 218 occur. Placing conductive wires 218 across depression 214 reduces losses from eddy current, compared to placing conductive wires 218 on leg faces 212, because less magnetic flux flows through wires 218 when wires 218 are placed across depression 214 than when wires 218 are placed on leg faces 212. For AC applications, conductive wires 218 may be positioned adjacent to exterior edges 222 of core base 204 to reduce eddy current losses in AC signals because magnetic flux reduces at locations farther away the central area 224 of core 202, where winding 220 surrounds core 202. For DC applications, wires may be placed at any location of leg faces 212.

In the example embodiments, electro-magnetic assembly 200 further includes epoxy 226. Before being cured, epoxy 226 flows around wires 218, without affecting the thickness of gap 217. Epoxy 226 may be deposited in any patterns such as strips (FIGS. 2B and 2D) or dots (FIG. 3B described later). Deposition of epoxy 226 may be performed by a machine, such as a pneumatical dispenser where the epoxy is dispensed through a syringe when a pedal of the dispenser is pressed. Dispending in a dotted pattern is more controllable than dispending in strips. For example, strips of epoxy may travel to windings and bind the windings with the core 202. Windings are fabricated with material such as copper, which has a much greater coefficient of thermal expansion (CTE) than that of the material of core 202. During the operation of electro-magnetic assembly 200, core 202 may break away from winding 220 due to the drastic differences in CTE, which may compromise the performance of electro-magnetic assembly 200.

FIGS. 3A and 3B show another example electro-magnetic assembly 200-3. Winding 220 is not shown in FIGS. 3A and 3B. Core 202 is an ER-ER core. In some known methods, a gap is constructed by grinding down some of legs 210 to a desired length. The grinding process needs to be strictly controlled to meet the tight tolerance of inductance, which may be impractical for a relatively small gap. In other known methods, a known gap spacer 108 is used, which has the problems of being difficult to manufacture and unsuitable for automation as described above.

In the example embodiment, core base 204 includes a winding leg 210-w and non-winding legs 210-nw. A winding leg refers to a leg arranged to be wound around by winding 220 (see FIGS. 2A and 2B). A non-winding leg refers to a leg not arranged to be wound around by winding 220. Wires 218 may be positioned on leg faces 212 of legs 210 such as non-winding legs 210-nw. Alternatively, wire 218 is positioned across depression 214, with one end of wire 218 positioned on first leg face 212-1 of first leg 210-1 and the other end of wire 218 positioned on second leg face 212-2 of second leg 210-2. Gap 217 defined by gap spacer 216 may be adjusted to a desired size by selecting wires 218 having a gauge corresponding to the desired gap size.

U-I core 202 (FIGS. 2A-2D) and ER-ER core 202 (FIGS. 3A and 3B) are described herein for illustration purposes only. The assemblies and methods disclosed herein may be applied with electro-magnetic assemblies having any core shape or any combination of core shapes, such as EI, ER, ERI, or PQI cores.

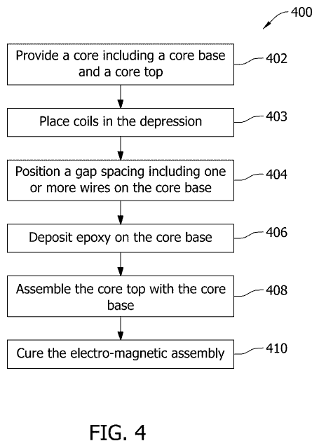

FIG. 4 is a flow chart of an example method 400 of assembling an electro-magnetic assembly. In the example embodiment, method 400 includes providing 402 a core. Method 400 also includes placing 403 coils in the depression of the core base of the core to construct the winding. Further, method 400 includes positioning 404 a gap spacer including one or more wires on the core base. Method 400 includes depositing 406 epoxy on the core base. Epoxy 226 may be deposited in various patterns, such as in a dotted pattern and/or in strips. Epoxy 226 may be deposited before positioning of gap spacer 216. For example, epoxy 226 may have been deposited before positioning of gap spacer 216 on core base 204 such that gap spacer 216 may be pressed onto epoxy 226. Because epoxy 226 is adhesive, depositing epoxy before positioning of gap spacer 216 may facilitate securing the location of gap spacer 216 on core base 204. Alternatively, epoxy 226 may be deposited after placement of gap spacer 216 on core base. For example, deposition of epoxy 226 and placement of gap spacer 216 may be performed at the same station. After gap spacer 216 is positioned on core base 204, without moving core base 204 or gap spacer 216, epoxy 226 is deposited over gap spacer 216, at least partially covering gap spacer 216.

In the example embodiment, method 400 includes assembling 408 the core top with the core base into the electro-magnetic assembly. Core top 206 and core base 204 may be assembled together by pressing core top 206 onto core base 204. Adhesive epoxy 226 binds core top 206 with core base 204. Method 400 also includes curing 410 the electro-magnetic assembly. For example, electro-magnetic assembly 200 may be cured in an oven to harden epoxy 226 and solidify the bonding between core top 206 and core base 204.

Method 400 may be partially or entirely automated, where at least part of method 400 is performed by a machine or an assembly line, especially positioning 404 the gap spacer on the core base. Automizing positioning 404 the gap spacer on the core base is advantageous in producing a robust electro-magnetic assembly and drastically reducing costs from tedious manual labor in known electro-magnetic assemblies and known methods of assembling electro-magnetic assemblies.

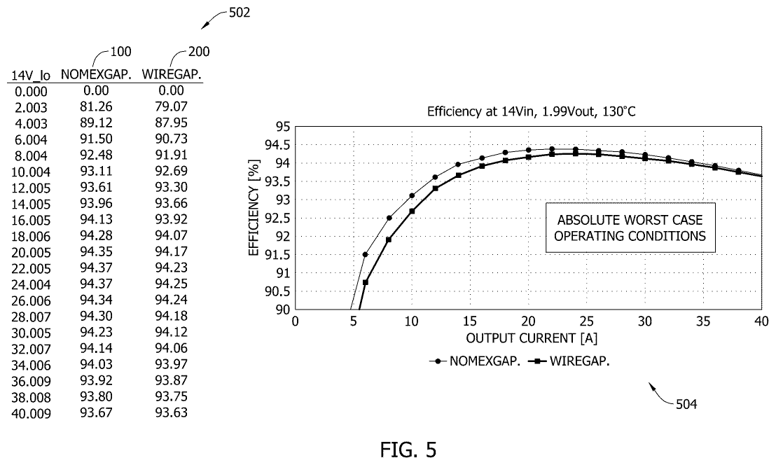

Efficiencies of electro-magnetic assembly 200-C and known electro-magnetic assembly 100 shown in FIG. 1 with a Nomex® gap spacer are compared. Testing on the electro-magnetic assembly 200 and known electro-magnetic assembly 100 was performed at three input voltages of 7 Vdc, 12 Vdc, and 14 Vdc, two output voltages of 0.99 Vdc and 1.99 Vdc, three ambient temperatures of −40° C., 25° C., and 130° C., and the output current ranging from 0 to 40 Adc. FIG. 5 shows a table 502 listing the efficiencies of electro-magnetic assembly 200 and known electro-magnetic assembly 100 and a plot 504 showing the worst case example of the input voltage at 14 V, the output voltage at 1.99 V, and the ambient temperature at 130° C. At the worst case, the effects of added losses from the wires are minimal. From 0 to 40 Adc, the added losses from gap spacer 216 is noticeable at low output currents, while being negligible at high output currents. Losses include i) losses from windings, which is proportional to DC current squared times the resistance of the winding, ii) losses from the core, which is a function of frequency of the AC signals and the AC excitation current, and iii) eddy current losses from gap spacer 216 due to the AC excitation current. The AC excitation current remain the same for a given input voltage and a given output voltage of the electro-magnetic assembly. Eddy current losses are at the maximum in the worse case example shown in plot 504. At low output currents, losses are dominated by the losses from windings. Therefore, the noticeable losses from gap spacer 216 at low currents do not noticeably affect performance of electro-magnetic assembly 200.

Because conductive wires cause eddy current losses from AC signals, especially high frequency AC signals, a person of ordinary skill is deterred from using conductive wires as gap spacers for electro-magnetic assemblies. By placing wires 218 adjacent to exterior edges 222 of core base 204, the losses from eddy current is reduced. The losses from eddy current may be further reduced by positioning wires 218 across depression 214.

Gap spacers with wires, however, greatly increase the speed of manufacturing and the reliability of the product. The manufacturing process may be fully automated without compromising the quality of the electro-magnetic assembly. Wires of different gauges in very small increments, especially conductive wires, are readily available, even in a manufacturing facility. If a different thickness of a gap spacer is needed, wires of corresponding thickness may be readily selected from the facility or ordered, thereby eliminating the tedious manual process of adjusting the thickness of a gap spacer by assembling a plurality of sheets of material for the gap spacer. The flexibility in the design of electro-magnetic assemblies is increased and costs in manufacturing is reduced. Further, wires do not fold or crease, thereby eliminating the tedious manual process in manufacturing known electro-magnetic assemblies of ensuring no fold or crease in the placed gap spacer. In addition, the effects of epoxy on the inductance of electro-magnetic assembly is reduced because epoxy flows around the wires, without affecting the thickness of the gap. Further, the processes required for known electro-magnetic assemblies such as cutting, stamping, or punching the material into the desired shape of gap spacers, are eliminated. The placement of wires does not have to be precise, especially for DC electro-magnetic assemblies or nonconductive wires. Accordingly, electro-magnetic assemblies described herein may be assembled in a robust and simplified manner. The assembling process of electro-magnetic assemblies described herein may be fully or partially automated, without compromising the quality of the electro-magnetic assemblies.

At least one technical effect of the systems and methods described herein includes (a) wire gap spacers for electro-magnetic assemblies; (b) gap spacers including electrically conductive wires; (c) gap spacers including electrically nonconductive wires; (d) placement of gap spacers that include electrically conductive wires to reduce losses in high frequency AC signals from eddy current, and (e) automized assembling methods of electro-magnetic assemblies.

Exemplary embodiments of assemblies and methods of electro-magnetic assemblies are described above in detail. The systems and methods are not limited to the specific embodiments described herein but, rather, components of the systems and/or operations of the methods may be used independently and separately from other components and/or operations described herein. Further, the described components and/or operations may also be defined in, or used in combination with, other systems, methods, and/or devices, and are not limited to practice with only the systems described herein.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An electro-magnetic assembly comprising:
a core comprising a core base and a core top, the core defining a depression sized to receive a winding; and
a gap spacer comprising one or more wires positioned between the core base and a core top.

2. The electro-magnetic assembly of claim 1, wherein at least one of the one or more wires is electrically conductive.

3. The electro-magnetic assembly of claim 1, wherein the one or more wires are positioned adjacent to an exterior edge of the core base.

4. The electro-magnetic assembly of claim 1, wherein at least one of the one or more wires is positioned across the depression.

5. The electro-magnetic assembly of claim 1, wherein at least one of the one or more wires is electrically nonconductive.

6. The electro-magnetic assembly of claim 1, wherein the core base comprises:
a body;
a first leg defining a first leg face; and
a second leg defining a second leg face,
wherein the first leg and the second leg extend from the body toward the core top, the depression positioned between the first leg and the second leg, and the first leg face and the second leg face facing the core top.

7. The electro-magnetic assembly of claim 6, where the one or more wires are positioned on the first leg face and/or the second leg face.

8. A method of assembling an electro-magnetic assembly, the method comprising:
providing a core including a core base and a core top, the core defining a depression sized to receive a winding;
placing coils in the depression to construct the winding;
positioning a gap spacer including one or more wires on the core base;
depositing epoxy on the core base;
assembling the core top with the core base into the electro-magnetic assembly; and
curing the electro-magnetic assembly.

9. The method of claim 8, wherein the method is automated.

10. The method of claim 8, wherein positioning the gap spacer further comprises positioning the one or more wires adjacent to an exterior edge of the core base.

11. The method of claim 8, wherein depositing the epoxy further comprises depositing the epoxy in a dotted pattern.

12. The method of claim 8, wherein positioning the gap spacer further comprises positioning one or more electrically conductive wires on the core base.

13. The method of claim 8, wherein positioning the gap spacer further comprises positioning at least one of the one or more wires across the depression.

14. The method of claim 8, wherein positioning the gap spacer further comprises positioning one or more electrically nonconductive wires on the core base.

15. The method of claim 8, wherein the core base includes:
a body;
a first leg defining a first leg face; and
a second leg defining a second leg face,
wherein the first leg and the second leg extend from the body, the depression positioned between the first leg and the second leg.

16. The method of claim 15, where positioning the gap spacer further comprises positioning the one or more wires on the first leg face and/or the second leg face.

17. The method of claim 8, wherein depositing the epoxy further comprises depositing the epoxy in strips.

18. The method of claim 8, wherein positioning the gap spacer further comprises pressing the one or wires on the epoxy.
